(19) United States
(12) Patent Application Publication
(10) Pub. No.: US 2020/0334615 A1
(43) Pub. Date: Oct. 22, 2020

(54) Predicting Business-Agnostic Contact Center Expected Wait Times With Deep Neural Networks

(71) Applicant: Google LLC, Mountain View, CA (US)

(72) Inventors: Alex Benjamin, Kirkland, WA (US); Yash Shah, Seattle, WA (US)

(73) Assignee: Google LLC, Mountain View, CA (US)

(21) Appl. No.: 16/390,409

(22) Filed: Apr. 22, 2019

(51) Int. Cl. G06Q 10/06; G06Q 30/00; G06N 3/08

(52) U.S. Cl. CPC G06Q 10/063114; G06N 3/08; G06Q 30/016

(57) ABSTRACT

A method for predicting an estimated wait time includes receiving a pending support request from a user. The pending support request is associated with a plurality of high-level features that include a number of active support agents, a number of available support agents, and a queue depth. The method also includes predicting an estimated wait time for the user of the pending support request using a wait time predictor model configured to receive the plurality of high-level features as feature inputs. The wait time predictor model is trained on a corpus of training support requests that include corresponding high-level features and a corresponding actual wait time. The method also includes providing the estimated wait time to the user that indicates an estimated duration of time until the pending support request is answered.

### TECHNICAL FIELD

This disclosure relates to predicting an estimated wait time for a support request from a user. In an example implementation, business-agnostic contact center expected wait times can be predicted with a wait time predictor model comprising a deep neural network.

### BACKGROUND

Many businesses invest a significant amount of resources into offering customer support for goods or services provided by the business. The businesses invest these resources, at least in part, to increase or provide a high degree of customer satisfaction. The customer's interaction with the customer support may strongly influence the customer's satisfaction. Specifically, how long the business estimates the customer will wait compared to how long the customer actually waits until the business establishes a connection between the customer and a customer support agent may strongly affect customer satisfaction.

### SUMMARY

One aspect of the disclosure provides a method for predicting an estimated wait time for a user support request. The method includes receiving, at data processing hardware, a pending support request from a user. The pending support request is associated with a plurality of high-level features that include a number of active support agents. Each active support agent is currently active in processing queued support requests. The high-level features also include a number of available support agents where each available support agent is currently available to process a queued support request. The high-level features also include a queue depth indicating a number of support requests waiting to be processed. The method further includes predicting, by the data processing hardware, an estimated wait time for the user of the pending support request using a wait time predictor model configured to receive the plurality of high-level features as feature inputs. The wait time predictor model is trained on a corpus of training support requests. Each training support request includes a corresponding plurality of high-level features and a corresponding actual wait time. The method also includes providing, by the data processing hardware, the estimated wait time to the user. The estimated wait time indicates an estimated duration of time until the pending support request is answered.

Implementations of the disclosure may include one or more of the following optional features. In some implementations, the plurality of high-level features associated with the pending support request further include at least one of an actual wait time for a previously answered support request, an identification of a business associated with the pending support request, or an identification of a business queue associated with the business. The plurality of high-level features, in some examples, further include at least one of: a time of day indication that indicates a time of day the pending support request was received or an average resolution time that is representative of an average amount of time support agents associated with the respective business identification and respective queue identification take to complete a corresponding support request.

Optionally, each training support request in the corpus of training support requests includes a plurality of historical support requests previously processed by the data processing hardware. The wait time predictor model, in some implementations, is trained at a configurable frequency using the corresponding plurality of high-level features and the corresponding actual wait time for each of the historical support requests during the configurable frequency. The configurable frequency may include once per day.

In some examples, the method further includes, after the pending support request is answered, determining, by the data processing hardware, an actual wait time for the user. The actual wait time indicates an actual duration of time from when the pending support request was received until the user receives the answer for pending support request. The method also includes tuning, by the data processing hardware, the wait time predictor model using the actual wait time for the pending support request. The method may also further include determining, by the data processing hardware, a loss of the wait time predictor model based on the estimated wait time predicted by the wait time predictor model and the actual wait time, determining, by the data processing hardware, whether the loss satisfies a threshold relative to a loss of a previously trained model, and reverting, by the data processing hardware, back to the previously trained model when the loss satisfies the threshold.

In some implementations, determining the loss includes using a mean squared error. Optionally, the predicted wait time model includes a neural network. The neural network may include a regressor deep neural network. The neural network may also include a deep neural network having a first hidden layer and a second hidden layer.

Another aspect of the disclosure provides a system for predicting an estimated wait time for a user support request. The system includes data processing hardware and memory hardware in communication with the data processing hardware. The memory hardware stores instructions that when executed on the data processing hardware cause the data processing hardware to perform operations. The operations include receiving a pending support request from a user. The pending support request is associated with a plurality of high-level features that include a number of active support agents. Each active support agent is currently active in processing queued support requests. The features also include a number of available support agents where each available support agent currently available to process a queued support request. The features also include a queue depth indicating a number of support requests waiting to be processed. The operations further include predicting an estimated wait time for the user of the pending support request using a wait time predictor model configured to receive the plurality of high-level features as feature inputs. The wait time predictor model is trained on a corpus of training support requests. Each training support request includes a corresponding plurality of high-level features and a corresponding actual wait time. The operations also include providing the estimated wait time to the user. The estimated wait time indicates an estimated duration of time until the pending support request is answered.

This aspect may include one or more of the following optional features. In some implementations, the plurality of high-level features associated with the pending support request further include at least one of an actual wait time for a previously answered support request, an identification of a business associated with the pending support request, or an identification of a business queue associated with the business. The plurality of high-level features, in some examples, further include at least one of: a time of day indication that indicates a time of day the pending support request was received or an average resolution time that is representative of an average amount of time support agents associated with the respective business identification and respective queue identification take to complete a corresponding support request.

Optionally, each training support request in the corpus of training support requests includes a plurality of historical support requests previously processed by the data processing hardware. The wait time predictor model, in some implementations, is trained at a configurable frequency using the corresponding plurality of high-level features and the corresponding actual wait time for each of the historical support requests during the configurable frequency. The configurable frequency may include once per day.

In some examples, the operations further include, after the pending support request is answered, determining an actual wait time for the user. The actual wait time indicates an actual duration of time from when the pending support request was received until the user receives the answer for pending support request. The operations also include tuning the wait time predictor model using the actual wait time for the pending support request. The operations may also further include determining a loss of the wait time predictor model based on the estimated wait time predicted by the wait time predictor model and the actual wait time, determining whether the loss satisfies a threshold relative to a loss of a previously trained model, and reverting back to the previously trained model when the loss satisfies the threshold.

In some implementations, determining the loss includes using a mean squared error. Optionally, the predicted wait time model includes a neural network. The neural network may include a regressor deep neural network. The neural network may also include a deep neural network having a first hidden layer and a second hidden layer.

The pending support request is associated with the plurality of high-level features or the high-level features are associated with the pending support request. High-level features being associated with a pending support request may include, for each of the high-level features, a value or number of the high-level feature obtained or collected or received in response to receipt of the pending support request (which may be an initial user support request received (e.g. via a web page) indicating that a user is interested in submitting an actual support request or may be an actual support request submitted by a user). For example, a value or number may be obtained from the received pending support request or may be obtained from the system when the pending support request is received. For example, the plurality of high-level features associated with the pending support request may comprise a number of active support agents, each active support agent currently active in processing queued support requests at the time of receipt of the pending support request; a number of available support agents, each available support agent currently available to process a support request at the time of receipt of the pending support request, and a queue depth indicating a number of support request waiting to be processed at the time of receipt of the pending support request.

By using high level features associated with the pending support request, including a number of active support agents and/or a number of inactive agents), a number of available support agents, and a queue depth to predict an estimated wait time for a user using the wait time predictor model, the implementations described herein can predict estimated wait times for users with a high degree of accuracy using data commonly and/or easily available to support request system. As the data used as input to the wait time predictor model is commonly/easily available, it is easy to collect and can be updated quickly with new data without the need for complex systems requiring costly calculations/instrumentations of support software. This is in contrast to typical queuing-theory models which require specific and occasionally difficult to measure information as inputs to the model such as n-order-derivative metrics (e.g., second derivative of online agent count, complex rolling-window metrics), or niche metrics, as would be required by complex queuing theory models, but that wouldn't otherwise provide any value or necessitate a preexisting metric collection.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 schematically illustrates an example system for predicting an estimated wait time for a customer support request.

FIG. 2 schematically illustrates an example of training a wait time predictor model of the system of FIG. 1A.

FIG. 3 schematically illustrates a support agent pool that includes active agents, available agents, and unavailable agents.

FIG. 4 schematically illustrates a queue that includes pending support requests to be answered by agents from a support agent pool.

FIG. 5 schematically illustrates high-level feature inputs for a wait time predictor model that predicts an estimated wait time.

FIG. 6 schematically illustrates a graphical user interface of a user device displaying an estimated wait time.

FIG. 7 schematically illustrates exemplary input strings used as indicator columns and embedding columns.

FIG. 8 is a flowchart of an example arrangement of operations for a method of predicting an estimated wait time for a customer support request.

FIG. 9 is a schematic view of an example computing device that may be used to implement the systems and methods described herein.

Like reference symbols in the various drawings indicate like elements.

### DETAILED DESCRIPTION

Traditional customer service queuing systems typically involve a customer calling a customer service phone number and being placed in a queue until a customer service agent is available to answer the call. The customer waits in this queue until connected to the agent. In an attempt to decrease telecom costs and increase customer satisfaction, businesses have begun offering virtual queuing. With a virtual queuing system, the customer calls a service number or requests service via an online portal. A customer support system then provides the customer with an estimated expected wait time. That is, the system informs the user of how long the system has predicted the user will wait in the virtual queue until the business calls the customer to connect to an available agent. Accordingly, the system places the customer in a virtual queue and when the customer nears the front of the queue, the business calls the customer and shortly thereafter connects the customer with the next available agent. This allows the business to minimize telecom costs and allows the customer to remain free until the call, thus increasing customer satisfaction. However, failure to provide an accurate expected wait time may decrease customer satisfaction.

Predicting customer expected wait times, for virtual queuing systems or other queuing systems, is a notoriously difficult exercise. Existing systems use well known mathematical formulations that are complex and require extensive instrumentation of the underlying software services to acquire specific or more detailed data. For example, existing systems can require specific or more detailed data such as n-order-derivative metrics (e.g., second derivative of online agent count, complex rolling-window metrics) in an online machine learning system, or niche metrics, as would be required by complex queuing theory models. This data may be costly to gather (i.e., excessive computation or storage) and can otherwise fail to provide any value or necessitate a preexisting metric collection. Yet, these complex systems still frequently fail to predict accurate wait times in many common scenarios. Because of this, businesses often resort to constant estimates or ranges which, while simple, are even less accurate. Further, existing solutions often require developing separate and unique models for every support queue offered, and therefore are not agnostic to the topic or the business of a support call. That is, many businesses offer a wide variety of services or products and typically offer a dedicated support queue per service or product because customer support agents are typically only trained to support specific services or products. Existing systems typically require a model to be developed for every support queue which scales poorly for large enterprises. Customer support systems benefit from a model that provides a high degree of accuracy across any number of business units or support queues without an unreasonable burden of collecting data to compute manually defined formulations.

Implementations herein are directed toward a support request system that implements a wait time predictor model for predicting an estimated wait time that indicates an estimated duration of time until a pending support request is answered. The system receives a plurality of high-level features (i.e., data commonly and/or easily available to the support request system) that include a number of active agents (i.e., the number of agents working), a number of available agents (i.e., the number of agents available to answer a support request), and a queue depth that indicates a number of support requests waiting to be processed. The pending support request is associated with the plurality of high-level features or the high-level features are associated with the pending support request. High-level features being associated with a pending support request may include, for each of the high-level features, a value or number of the high-level feature obtained or collected or received in response to receipt of the pending support request (which may be an initial user support request received (e.g. via a web page) indicating that a user is interested in submitting an actual support request or may be an actual support request submitted by a user). For example, a value or number may be obtained from the received pending support request or may be obtained from the system when the pending support request is received. For example, the plurality of high-level features associated with the pending support request may comprise a number of active support agents, each active support agent currently active in processing queued support requests at the time of receipt of the pending support request; a number of available support agents, each available support agent currently available to process a support request at the time of receipt of the pending support request, and a queue depth indicating a number of support request waiting to be processed at the time of receipt of the pending support request. The high-level features may also include an identification (ID) of a business associated with the pending support request, an ID of a business queue associated with the business, and/or a previous actual wait time (i.e., the amount of time the most recently answered support request waited in the queue).

The wait time predictor model is trained on a corpus of training support requests that each include a corresponding plurality of high-level features and a corresponding actual wait time. The wait time predictor model, after receiving the high-level features, predicts an estimated wait time for the customer of the pending support request. The system provides the estimated wait time to the customer to indicate an estimated duration of time until the pending support request is answered, i.e., until the customer is connected to a customer support agent. The wait time predictor model provides a business-agnostic solution that may be deployed across any business/enterprise, while easily scaling to the size of the business/enterprise in a diverse, high-volume environment with only minimal, if any, instrumentation of software support services.

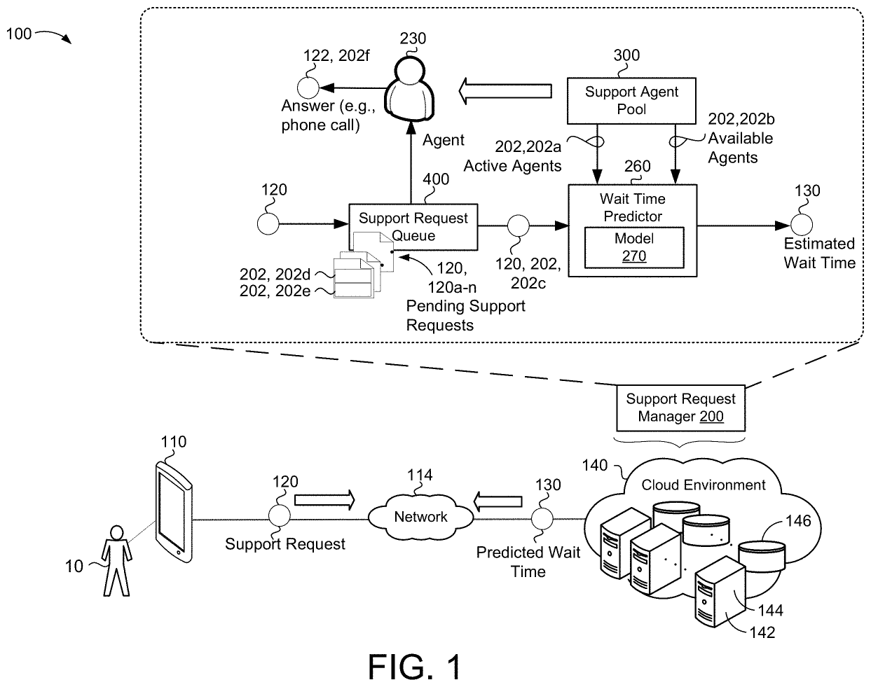

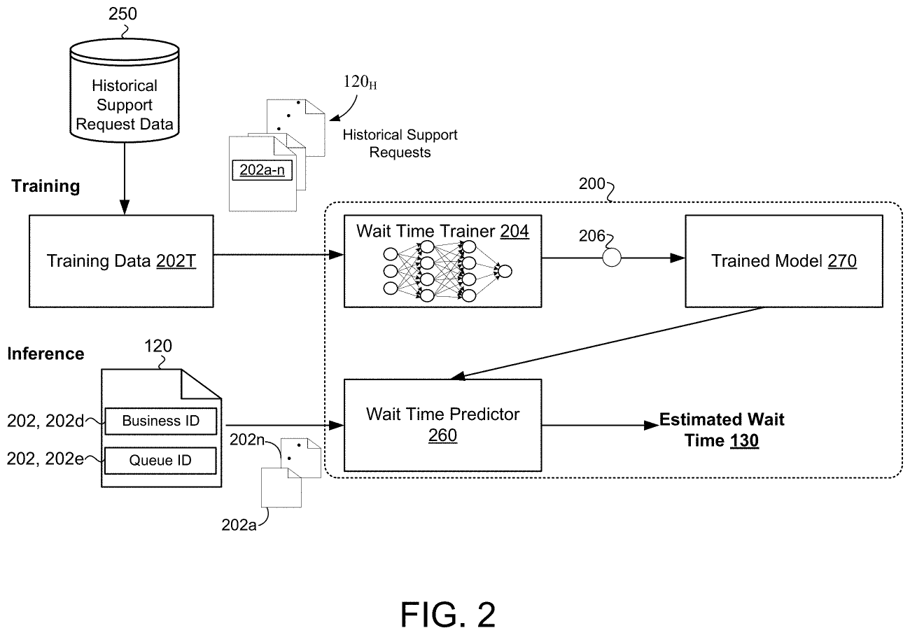

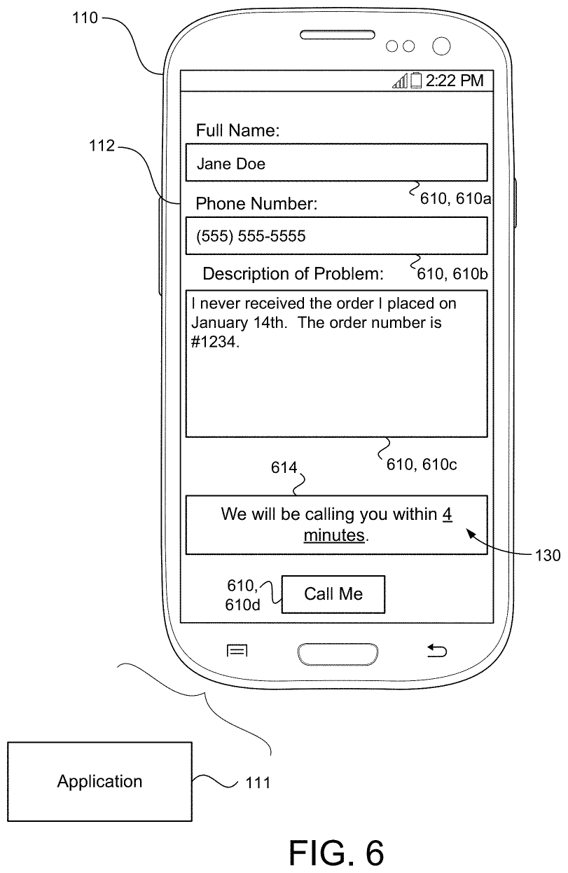

Referring to FIGS. 1 and 2, in some implementations, a system 100 includes a user device 110 (e.g., customer device) that issues a support request 120 from a user 10 (e.g., customer) associated with the user device 110. The support request 120 is a request generated by the user 10 for assistance from an entity (e.g., a business or company). For example, the user 10 may wish to ask a question regarding a product or service of the associated business. The user 10 may generate the support request 120 via the user device 110 through, for example, a phone call, website, or mobile application. That is, the user 10 may interact with the business (e.g., by calling the business or visiting an online portal) and follow prompts to submit the support request 120. The business may elicit information (e.g., name, product/service description, description of problem, etc.) to ensure the user's support request 120 is directed to an appropriate group of customer support agents 230. For example, the business may offer a form through an application 111 (FIG. 6), such as a web-based application or mobile application, requesting input of relevant information by the user 10 prior to submitting the support request 120.

The user device 110 may communicate the support request 120 to a remote system 140 via a network 114. The remote system 140 may be a distributed system (e.g., cloud computing environment) having scalable/elastic resources 142. The resources 142 include computing resources 144 (e.g., data processing hardware) and/or storage resources 146 (e.g. memory hardware). In some implementations, the remote system 140 executes a support request manager 200 configured to receive the support request 120 from the user 10. The support request manager 200, using the support request 120 and a plurality of high-level features 202, 202a-n associated with the support request 120, returns a predicted wait time 130 to the user 10. The predicted wait time (also referred to as “estimated wait time”) 130 indicates an estimated duration of time until the pending support request 120 is answered 122 (i.e., the amount of time until a customer support agent 230 associated with the business directly interacts with the user 10). As used herein, the term “answer” in reference to an agent 230 answering 122 a support request 120 indicates that the agent 230 has begun servicing the support request 120 in some fashion (e.g., the agent 230 has connected to the user 10 via a phone call or via a chat interface). The answer 122 to the support request 120 may be associated with an actual wait time 202f indicating an actual duration of time that the support request 120 was pending until receiving an answer 122 from the customer support agent 230.

In the example shown, the support request manager 200 includes a support request queue 400, a support agent pool 300, and a wait time predictor 260. The support request 120 received from the user device 110 is input to the support request queue 400 and remains pending in the support request queue 400 with one or more other support requests 120 until a customer support agent 230 becomes available to answer 122 the support request 120. Support requests 120 pending in the support request queue 400 may be answered on a first-in first-out basis. In some examples, the support request queue 400 is partitioned into corresponding business queues each associated with a corresponding business/enterprise that a support request 120 is directed to. Accordingly, each support request 120 may specify a business ID 202d, identifying the business associated with the pending support request 120, and/or queue ID 202e identifying a respective support request queue 400 for queuing the pending support request 120. While the support request 120 is pending within the support request queue 400, the wait time predictor 260 is configured to predict the estimated wait time 130 for the pending support request 120. The manager 200 may then provide the estimated wait time 130 to the user device 110 associated with the user 10.

In some examples, the wait time predictor 260 uses a wait time predictor model 270 configured to receive the plurality of high-level features 202, 202a-n associated with the pending support request 120 as feature inputs. The plurality of high-level features 202 may include one or more of a number of active agents 202a, a number of available agents 202b, a queue depth 202c, the business ID 202d, the queue ID 202e, or a previous actual wait time 202f associated one or more other support requests 120 from the support request queue 400 that were recently answered 122 by an agent 230. The model 270 may obtain some of the high-level features 202 (e.g., the business and queue IDs 202d, 202e) directly from the pending support request 120, while obtaining other high-level features 202 from other sources (e.g. in response to or on receipt of the pending support request 120). For example, the model 270 may receive the number of active customer support agents 202a and the number of available customer support agents 202b from the support agent pool 300, and receive the queue depth 202c from the support request queue 400 in response to, for example, receipt of the pending support request 120 or receipt of interest in submitting such a request (i.e., when a user 10 visits a webpage to investigate submitting a ticket). The high-level features 202 all represent data already commonly captured by customer support systems, and thus will generally not request any extraneous user data retention or costly calculations/instrumentations of support software. Other easily gathered high-level features 202 may also be included. For example, a time of day indication 202n that indicates a time of day the pending support request 120 was received may be included. In another example, the high-level features 202 include an average resolution time that is representative of the average amount of time support agents 230 associated with the respective business ID 202d and/or respective queue ID 202e take to complete a corresponding support request 120. Described in greater detail below, the wait time predictor model 270 is trained on training data 202T that includes corresponding high-level features 202.

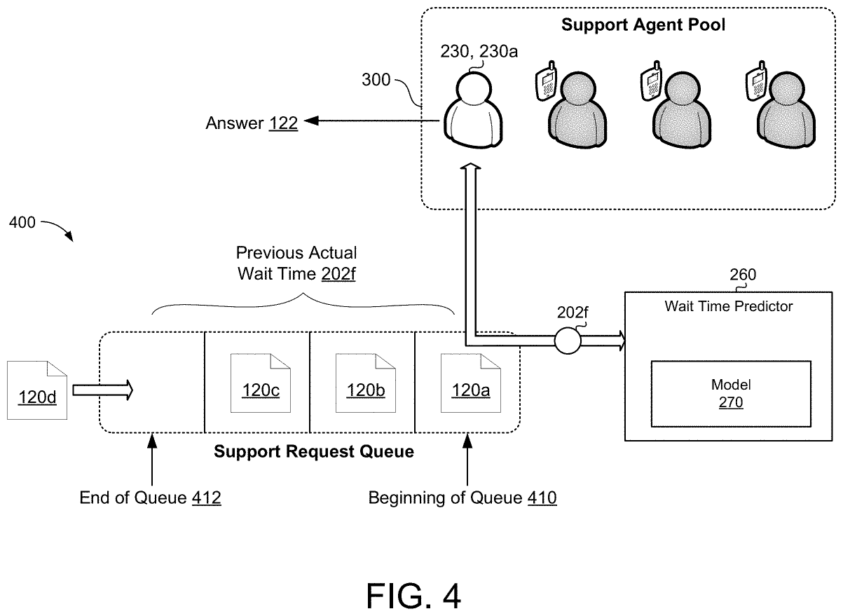

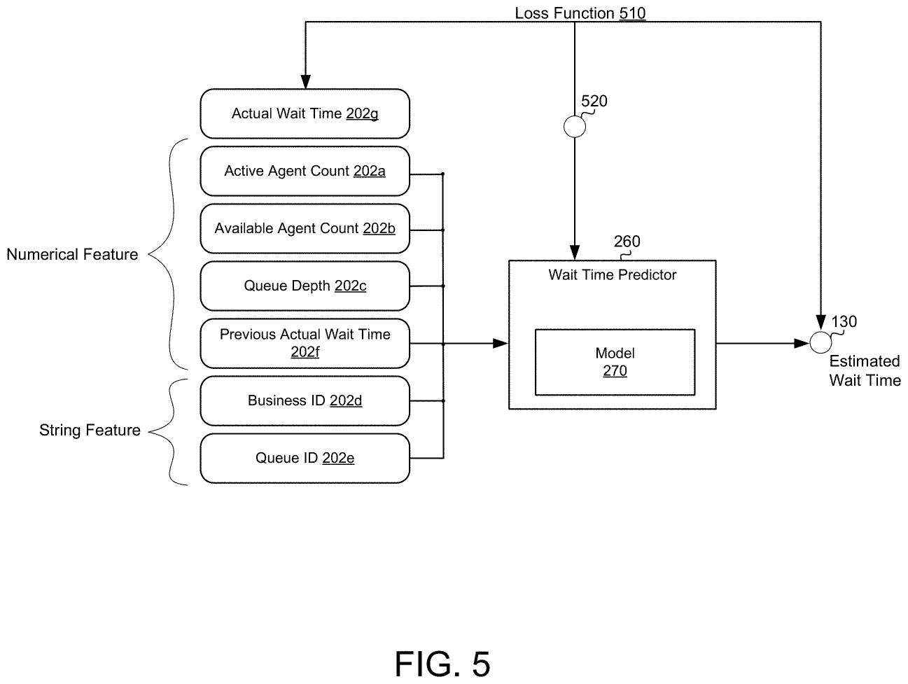

Referring to FIG. 2, in some implementations, the wait time predictor model 270 is trained on training data 202T obtained from a historical support request data store 250. The historical support request data store 250 may reside on the storage resources 146 of the distributed system 140, or may reside at some other remote location in communication with the system 140. The training data 202T includes a corpus of historical support requests 120_{H} (also referred to as ‘training support requests 120_{H}’), wherein each historical support request 120_{H} includes a corresponding plurality of high-level features 202a-n and a corresponding actual wait time 203. For example, each historical support request 120_{H} includes one or more of a number of active agents 202a, a number of available agents 202b, a queue depth 202c, a business ID 202d, a queue ID 202e, or an actual wait time 202f associated with the corresponding historical support request 120_{H}. Here, the actual wait time 202f associated with the corresponding historical support request 120_{H} is known since the support request 120_{H} is “historical”, and thus, already processed by the manager 200. Thus, the actual wait time 203 associated with the corresponding historical support request 120_{H} indicates an actual duration of time the historical support request 120_{H} was pending before being answered. Moreover, the historical support request 120_{H} may further include a previous actual wait time 202f associated one or more past support requests 120 that were answered before the corresponding historical support request 120_{H}. Actual wait times 203 are described in greater detail below with reference to FIGS. 4 and 5. In the example shown, the training data 202T passes to a wait time trainer 204 for training the wait time predictor model 270. Based on the training data 202T, the wait time trainer 204 is able to model support request parameters 206 to train the wait time predictor model 270. Once trained, the wait time predictor model (e.g., trained model) 270 is used by the wait time predictor 260 during inference for predicting estimated wait times 130 for corresponding pending support requests 120. Thus, using training data 202T associated with a corpus of historical support requests 120_{H} each including a corresponding plurality of high-level features 202 and/or a known corresponding actual wait time 202f, the wait time predictor model 270 is trained to predict estimated wait times 130.

The wait time predictor model 270 may include a neural network. For instance, the wait time trainer 204 may map the training data 202T to output data to generate the neural network model 270. Generally, the wait time trainer 204 generates hidden nodes, weights of connections between the hidden nodes and input nodes that correspond to the training data 202T, weights of connections between the hidden nodes and output nodes, and weights of connections between layers of the hidden nodes themselves. Thereafter, the fully trained neural network model 270 may be employed against input data (e.g., pending support request 120) to generate unknown output data (e.g., the estimated wait time 130). In some examples, the neural network model 270 is a deep neural network (e.g., a regressor deep neural network) that has a first hidden layer and a second hidden layer. For example, the first hidden layer may have sixteen nodes and the second hidden layer may have eight nodes. The wait time trainer 204 typically trains the model 270 in batches. That is, a model 270 is typically trained on a group of input parameters (i.e., high-level features 202 and actual wait times 203) at a time. In some implementations, the trained model 270 is trained with a batch size of ten. The implementations of the wait time predictor model described herein uses pre-existing historical data, with minimal preprocessing, thereby increasing the efficacy of the deep neural network approach.

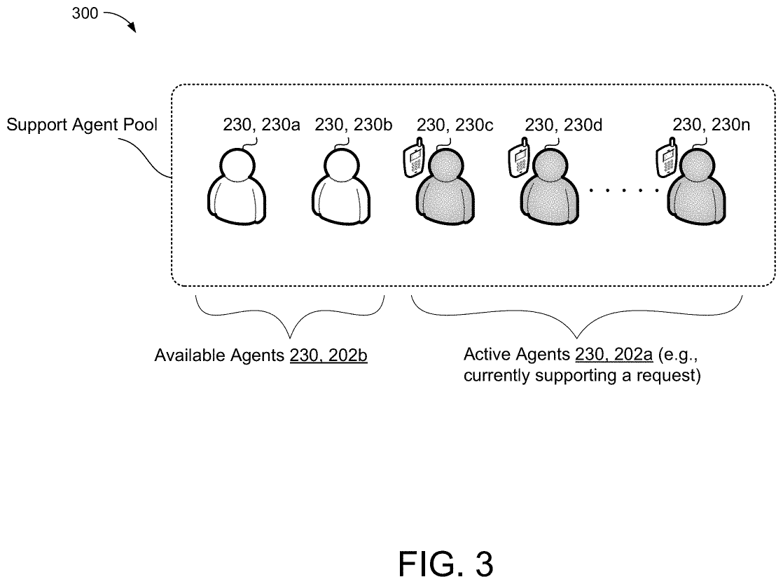

Referring now to FIG. 3, an example support agent pool 300 includes a total number of agents 230, 230a-n capable of answering the support request 120. For example, a call center may have five total agents 230 currently present at a call center to answer support requests for a given business unit, product, or service. A portion of the support agents 230 in the pool 300 may include active agents 202a that are currently active in processing queued support requests 120. A remaining portion of the support agents 230 in the pool 30 may include available agents 202b associated with agents 230 currently available to process a queued support request 120. In other words, the number of available agents 202b consists of the number of agents 230 who are currently free to answer a support request. In the example shown, among the agents 230 in the support agent pool 300, three agents 230c, 230d, 230n are classified as active agents 202a (i.e., agents 230 currently supporting customers) and two agents 230a, 230b are classified available agents 202b.

Referring back to FIG. 1, the wait time predictor model 270 receives, in addition to the number of active agents 202a and the number of available agents 202b, a queue depth 202c from the support request queue 400. The queue depth 202c indicates a number of support requests 120 currently waiting (i.e., pending) to be processed. Put another way, the queue depth 202c represents how many users 10 are currently waiting in line (i.e., the queue 400) to have their respective support request 120 answered. For example, a queue depth 202c equal to zero would indicate there are currently no pending support requests 120 within the queue 400, while a queue depth 202c equal to eight (8) would indicate there are currently eight separate pending support requests 120 within the queue 400. Typically, agents 230 answer queued support requests 120 in order. That is, before an agent 230 provides an answer 122 to a respective support request 120, agents 230 will generally have already provided answers 122 to all of the support requests 120 received earlier than the respective support request 120.

FIG. 4 shows the support request queue 400 receiving support requests 120, 120a-n from different users 10 (e.g., customers). In the example shown, the queue 400 may be associated with a particular business/enterprise and may correspond to a First-In First-Out (FIFO) queue. That is, support requests 120 at a beginning 410 of the queue 400 are next in line to be answered and support requests 120 just arriving are placed at an end 412 of the queue 400. For example, the support request 120a was placed in the queue 400 prior to the other support requests 120b, 120c, and is therefore next in line at the beginning 410 to be answered. When an agent 230a becomes available, the agent 230a will answer 122 or respond to the next support request 120a in the queue 400. In some examples, upon the agent 230a answering the support request 120a, an actual wait time 202f is obtained for the support request 120a for use in tuning/training the wait time predictor model 270. For instance, the actual wait time 202f and the support request 120a may be stored in the historical support request data store 250 for use as training data 202T, as described above with reference to FIG. 2. Additionally or alternatively, the actual wait time 202f for the support request 120a may be applied as a high-level feature 202 for predicting an estimated wait time 130 for one or more support requests 120 subsequently received (e.g., support request 120d) by the queue 400. In some implementations, the wait time predictor model 270 stores only a single previous actual wait time 202f. That is, each time an agent 230 answers a support request 120, the previous actual wait time 202f is overwritten with a new value. In other implementations, multiple previous actual wait times 202f are stored (e.g., within the historical support request data store 250 (FIG. 2)). The wait time predictor 260 may statistically process the multiple previous actual wait times 202f (e.g., find an average) for use as training data 202T for training the wait time predictor model 270.

With continued reference to FIG. 4, the most recently received support request 120d is added to the end 412 of the queue 400. As agents 230 answer support requests 120, the support request 120d will move forward in the queue 400 until it is at the beginning 410 of the queue 400 and then answered by an agent 230. When the support request 120d is added to the queue 400, the wait time predictor model 270 will predict an estimated wait time 130 using the high-level features 202 associated with the support request 120d (i.e., high-level features 202 that correspond to states and statuses of the system 100 at the time the support request 12d0 is received) and assign the predicted estimated wait time 130 to the corresponding support request 120d. Here, the manager 200 may communicate the estimated wait time 130 to the user device 110 that input the support request 120d. When an agent 230 answers 122 the support request 120d, the actual wait time 202g for the support request 120d may be obtained for comparison against the corresponding estimated wait time 130 to further tune or train the model 270.

Referring now to FIG. 5, the wait time predictor 260 is configured to receive a plurality of high-level features 202 associated with a support request 120. Some of the features may be numerical features 202 (e.g., the active agent count 202a, the available agent count 202b, the queue depth 202c, and the actual wait time 202f) and some features may be string features 202 (e.g., the business ID 202d and the queue ID 202e). Using one or more of these features 202, the model 270 predicts the estimated wait time 130. When the actual wait time 202f is obtained upon a support request 120 being answered (i.e., a duration of time the support request 120 spent in the queue 400 before an agent 230 answers the support request 120), the predictor 260 may determine a loss 520 between the estimated wait time 130 and the actual wait time 202f. That is, the wait time predictor 260 may use a loss function 510 (e.g., a mean squared error loss function) to determine a loss 520 of the estimated wait time 130, where the loss 520 is a measure of how accurate the predicted wait time estimate 130 is relative to the actual wait time 202f. The predictor 260, in some implementations, uses the loss 520 to further train or tune the model 270.

In some examples, the predictor 260 (or support request manager 200 or any other systems executing on the data processing hardware 144) tunes the model 270 with the loss 520 and/or any associated high-level features 202 immediately after the predictor 260 receives the actual wait time 202f of a recently answered support request 120. In other examples, the predictor 260 trains the model 270 at a configurable frequency. For example, the predictor 260 may train the model 270 once per day and the training data 202T may include all of the support requests 120 and associated features 202 that occurred that day (i.e., historical support requests 120_{H} of FIG. 2). It is understood that the configurable frequency is not limited to once per day and may include any other period of time (e.g., once per hour, once per week, etc.). For example, the predictor 260 may train the model 270 automatically once per day (or some other predetermined period of time) to tune the model based on the prior day's data. In some implementations, the loss 520 of the tuned or retrained model 270 is compared against the loss of a previous model 270 (e.g., the model 270 trained from the previous day), and if the loss 520 of the new model 270 satisfies a threshold relative to the loss 520 of the previous model 270 (e.g., the loss 520 of the model 270 trained today versus the loss 520 of the model 270 trained yesterday), the wait time predictor 260 may revert to the previously trained model 270 (i.e., discard the newly tuned or retrained model 270). Put another way, if the model 270 is further trained on new training data 202T (e.g., collected from that day), but the loss 520 indicates that the accuracy of the model 270 has declined, the model 270 may revert to the previous, more accurate model 270.

Referring back to FIG. 1, the wait time predictor model 270, based on the high-level features 202 and the pending support request 120, predicts the estimated wait time 130 for the received pending support request 120 and the support request manager 200 provides the estimated wait time 130 to the user device 110 associated with the user 10 (i.e., the customer). The user device 110 may correspond to a computing device, such as a desktop workstation, laptop workstation, mobile device (e.g., smart phone or tablet), wearable device, smart appliance, smart display, or smart speaker. That is, the user device 110 can be any computing device capable of communicating with the remote system 140 through the network 114. The support request manager 200 can provide the estimated wait time 130 to the user device 110 as a voice response when the user device 110 submits the request 120 via a phone call, or the manager 200 can provide the estimated wait time 130 as an electronic message sent to the user device 110. The electronic message could include text for display by the user device 110 or the electronic message could include a text-to-speech message causing the user device 110 to audibly output synthesized speech that conveys the estimated wait time 130 to the user 10. Here, the synthesized speech may be provided over the network 114 from the support request manager 200 or the user device 110 could include a text to speech (TTS) module for converting text into the synthesized speech. In some examples, the user device 110 execute voice assistant software and capture an utterance associated with the support request 120 spoken by the user and sends the support request 120 to the support request manager 200. Here, the user 10 may use spoken commands that instruct the user device 110 to provide the support request 120 to the support request manager 200. The user device 110 may use speech recognition locally to convert the utterance of the support request 120 into corresponding text and send the text representing the support request 120 to the support request manager 200. On the other hand, the user device 110 may send audio data representing the support request 120 to the support request manager 200 and the support request manager 200 may leverage a speech recognizer to convert the audio into text.

Referring now to FIG. 6, in some implementations, the user device 110 communicates with the support request manager 200 by accessing a webpage, web-based application, or via a dedicated software application 111 executing on the user device 110. In the example shown, the user device 110 executes a graphical user interface (GUI) 112 for display on the user device 110 to input the support request 120. The GUI may include one or more fields 610, 610a-n for inputting details or parameters to define the support request 120. For instance, a name field 610a may permit the user 10 to input (e.g., by typing) a name of the user 10 (e.g., Jane Doe), a phone number field 610b to input a contact phone number for the user 10 (e.g., (555) 555-5555), and a problem description field 610c. In the example shown, the user 10 indicates in the problem description field 610c that she never received an order placed on January 14^{th} with order number #1234. The GUI may also include a field 610d for completing the support request 120. For example, a “Call Me” button may complete the support request 120 and inform the support request manager 200 that the user 10 wises to enter the queue 400 and receive a call (i.e., answer 122) from the support request manager 200 when the user 10 is at the beginning 410 of the queue 400. It is understood that the 10 user may input the details or parameters via other means. For example, the GUI 112 or other software 111 executing on the user device 110 may allow the user 10 to enter the details as speech inputs captured via a microphone of the user device 110. Similarly, the user 10 may simply use the user device 110 as a telephone to place a call to the support request manager 200, whereby the user 10 simply speaks the details for the support request 120 to an operator.

In some implementations, the support request manager 200 will provide the estimated wait time 130 to the user 10 after the user submits the support request 120 (e.g., the user 10 presses the Call Me button 610d). That is, the user submits the support request 120 and then receives the estimated wait time 130. In other implementations, and in the example shown, the user device 110 may receive and display the estimated wait time 130 in a field 614 of the GUI 112 prior to formally submitting the support request 120 and entering the queue 400. That is, the support request manager 200 may collect the data (e.g., high-level features 202) to predict the estimated wait time 130 when, for example, the user 10 shows interest in submitting a support request 120 via selecting a link on a webpage. In this way, the user 10 may decide prior to entering the queue 400 if the wait is satisfactory.

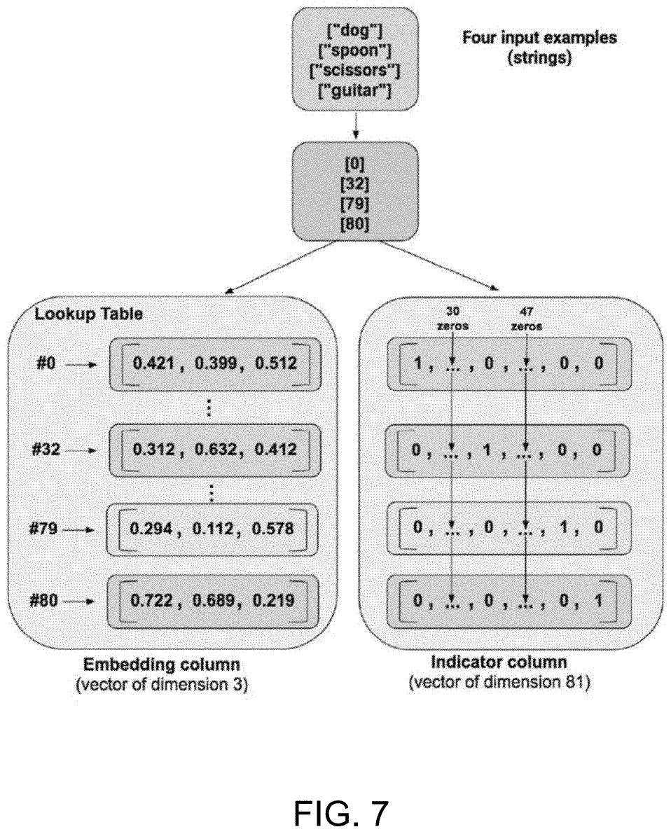

Referring now to FIG. 7, a portion of the high-level features 202 may include categorical features. For example, the business ID 202d and the queue ID 202e are categorical features. Categorical features are features that are not naturally in a numerical form and must be encoded into a numerical form prior to being inputted to the wait time predictor model 270. That is, the business ID 202d and queue ID 202e may be a string feature (FIG. 5) that requires encoding. In some implementations, the string features 202 are one-hot encoded. Put another way, the string features 202 (i.e., the business ID 202d and the queue ID 202e) may be treated as indicator columns to represent the categorical data in a manner that the wait time predictor model 270 may use.

In the example shown, an input string feature may include 81 different string inputs (i.e., the input may equal any of the 81 different strings) and each of the 81 strings is assigned a value between 0 and 80. Of the four exemplary strings shown, “dog” is assigned a value of [0], “spoon” is assigned a value of [32], “scissors” is assigned a value of [79], and “guitar” is assigned a value of [80]. When represented as indicator columns, the strings are one-hot encoded in vectors with dimensions of 81. That is, a vector of eighty ‘0’ and single ‘1’ represents each of the strings, where the position of the ‘1’ in the vector indicates which of the 81 strings the vector is associated with (i.e., the matching category has a value of ‘1’ and the rest have a value of ‘0’). For example, “dog” with a value of [0] is represented as a ‘1’ at the first element of the vector, while “guitar” with a value of [80] is represented as a ‘1’ at the last element of the vector. Similarly, “spoon” with a value of [32] is represented with a ‘1’ at the 32nd element of the vector and “scissors” with a value of [79] is represented with a ‘1’ at the 79th element of the vector. As the number of categories increases (i.e., the number of possible string inputs increase), the length of the vector similarly increases. For example, if there are a million possible inputs, the vector must be a million elements long. As the number of categories grow large, training the model 270 with indicator columns increases in difficulty (e.g., an increase in computing resources, an increase in training time, etc.).

In other implementations, the categorical features (i.e., string features 202) are represented as embedding columns. An embedding column stores categorical data in a lower-dimensional vector than an indicator column. When using embedding columns, in the example shown, a lookup table with 81 rows is created. Each row corresponds to one of the possible 81 input strings and each row includes a three-element vector. The lookup table is consulted for each string feature. For example, “dog,” with a value of [0], is assigned the three-element vector at row 0 of the lookup table (e.g., [0.421, 0.399, 0.512]). Similarly, “guitar,” with a value of [80], is assigned the three-element vector at row 80 (e.g., [0.722, 0.689, 0.219]). It is understood that the actual values within the lookup tables may be any values. In some examples, the values are assigned during training. Embedding columns, in addition to decreasing the dimensions of input vectors, also allows for representing relationships between categorical values. For example, “phone sales” may be assigned to be semantically more similar to “phone support” than “account support.”

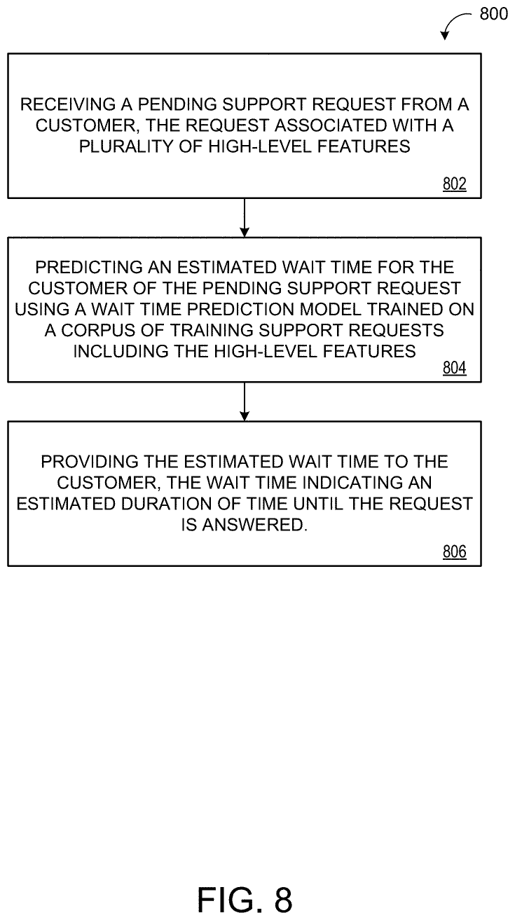

FIG. 8 is a flowchart of an example method 800 for providing an estimated wait time 130 to a user 10. The method 800 may be described with reference to FIGS. 1-7. The method 800 starts at operation 802 by receiving, at data processing hardware 144, a pending support request 120 from a customer 10. The pending support request 120 is associated with a plurality of high-level features 202 that include a number of active support agents 202a, a number of available support agents 202b, and a queue depth 202c. Each active support agent 202a is currently active in processing queued support requests 120 (e.g. at the time of receipt of the pending support request 120), while each available support agent is currently available (e.g., not currently supporting a support request 120 at the time of receipt of the pending support request 120) to process queued support requests 120. The queue depth 202c indicates a number of support requests 120 waiting to be processed (e.g. at the time of receipt of the pending support request 120).

The method 800, at operation 804, includes predicting, by the data processing hardware 144, an estimated wait time 130 for the customer or user 10 of the pending support request 120 using a wait time predictor model 270 configured to receive the plurality of high-level features 202 as feature inputs. The wait time predictor model 270 is trained on a corpus of training support requests 120_{H}, each training support request 120_{H} including a corresponding plurality of high-level features 202 and a corresponding actual wait time 202g.

The method 800, at operation 806, includes providing, by the data processing hardware 144, the estimated wait time 130 to the customer 10. The estimated wait time 130 indicates an estimated duration of time until the pending support request 120 is answered (e.g., by an agent 230). In some implementations, the plurality of high-level features 202 associated with the pending support request 120 further include at least one of an actual wait time 202f for a previous support request 120_{H}, an identification of a business 202d associated with the pending support request 120, or an identification of a business queue 202e associated with the business.

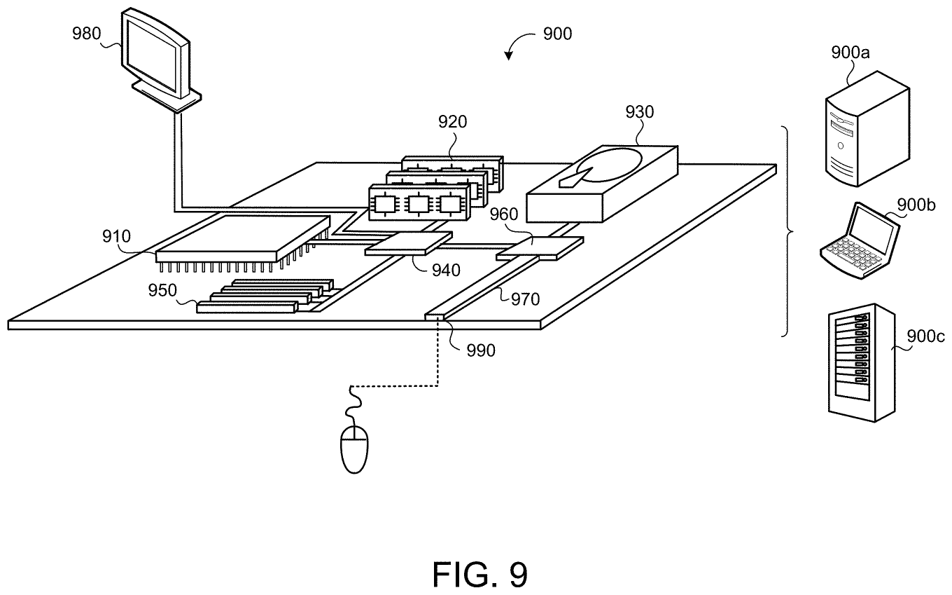

FIG. 9 is schematic view of an example computing device 900 that may be used to implement the systems and methods described in this document. The computing device 900 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 900 includes a processor 910, memory 920, a storage device 930, a high-speed interface/controller 940 connecting to the memory 920 and high-speed expansion ports 950, and a low speed interface/controller 960 connecting to a low speed bus 970 and a storage device 930. Each of the components 910, 920, 930, 940, 950, and 960, are interconnected using various busses, and may be mounted on a common motherboard or in other manners as appropriate. The processor 910 can process instructions for execution within the computing device 900, including instructions stored in the memory 920 or on the storage device 930 to display graphical information for a graphical user interface (GUI) on an external input/output device, such as display 980 coupled to high speed interface 940. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 920 stores information non-transitorily within the computing device 900. The memory 920 may be a computer-readable medium, a volatile memory unit(s), or non-volatile memory unit(s). The non-transitory memory 920 may be physical devices used to store programs (e.g., sequences of instructions) or data (e.g., program state information) on a temporary or permanent basis for use by the computing device 900. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 930 is capable of providing mass storage for the computing device 900. In some implementations, the storage device 930 is a computer-readable medium. In various different implementations, the storage device 930 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 920, the storage device 930, or memory on processor 910.

The high speed controller 940 manages bandwidth-intensive operations for the computing device 900, while the low speed controller 960 manages lower bandwidth-intensive operations. Such allocation of duties is exemplary only. In some implementations, the high-speed controller 940 is coupled to the memory 920, the display 980 (e.g., through a graphics processor or accelerator), and to the high-speed expansion ports 950, which may accept various expansion cards (not shown). In some implementations, the low-speed controller 960 is coupled to the storage device 930 and a low-speed expansion port 990. The low-speed expansion port 990, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 900a or multiple times in a group of such servers 900a, as a laptop computer 900b, or as part of a rack server system 900c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A method comprising:
receiving, at data processing hardware, a pending support request from a user, the pending support request associated with a plurality of high-level features comprising:
a number of active support agents, each active support agent currently active in processing queued support requests;
a number of available support agents, each available support agent currently available to process a queued support request; and
a queue depth indicating a number of support requests waiting to be processed;
predicting, by the data processing hardware, an estimated wait time for the user of the pending support request using a wait time predictor model configured to receive the plurality of high-level features as feature inputs, the wait time predictor model trained on a corpus of training support requests, each training support request comprising a corresponding plurality of high-level features and a corresponding actual wait time; and
providing, by the data processing hardware, the estimated wait time to the user, the estimated wait time indicating an estimated duration of time until the pending support request is answered.

2. The method of claim 1, wherein the plurality of high-level features associated with the pending support request further comprises at least one of an actual wait time for a previously answered support request, an identification of a business associated with the pending support request, or an identification of a business queue associated with the business.

3. The method of claim 2, wherein the plurality of high-level features further comprise at least one of:
a time of day indication, the time of day indication indicating a time of day the pending support request was received; or
an average resolution time, the average resolution time representative of an average amount of time support agents associated with the respective business identification and respective business queue identification take to complete a corresponding support request.

4. The method of claim 1, wherein each training support request in the corpus of training support requests comprise a plurality of historical support requests previously processed by the data processing hardware.

5. The method of claim 4, wherein the wait time predictor model is trained at a configurable frequency using the corresponding plurality of high-level features and the corresponding actual wait time for each of the historical support requests during the configurable frequency.

6. The method of claim 5, wherein the configurable frequency comprises once per day.

7. The method of claim 1, further comprising, after the pending support request is answered:
determining, by the data processing hardware, an actual wait time for the user, the actual wait time indicating an actual duration of time from when the pending support request was received until the user receives the answer for pending support request; and
tuning, by the data processing hardware, the wait time predictor model using the actual wait time for the pending support request.

8. The method of claim 7, further comprising:
determining, by the data processing hardware, a loss of the wait time predictor model based on the estimated wait time predicted by the wait time predictor model and the actual wait time;
determining, by the data processing hardware, whether the loss satisfies a threshold relative to a loss of a previously trained model; and
reverting, by the data processing hardware, back to the previously trained model when the loss satisfies the threshold.

9. The method of claim 8, wherein determining the loss comprises using a mean squared error.

10. The method of claim 1, wherein the predicted wait time model comprises a neural network.

11. The method of claim 10, wherein the neural network comprises a regressor deep neural network.

12. The method of claim 10, wherein the neural network comprises a deep neural network having a first hidden layer and a second hidden layer.

13. A system comprising:
data processing hardware; and
memory hardware in communication with the data processing hardware, the memory hardware storing instructions that when executed on the data processing hardware cause the data processing hardware to perform operations comprising:
receiving a pending support request from a user, the pending support request associated with a plurality of high-level features comprising:
a number of active support agents, each active support agent currently active in processing queued support requests;
a number of available support agents, each available support agent currently available to process a queued support request; and
a queue depth indicating a number of support requests waiting to be processed;
predicting an estimated wait time for the user of the pending support request using a wait time predictor model configured to receive the plurality of high-level features as feature inputs, the wait time predictor model trained on a corpus of training support requests, each training support request comprising a corresponding plurality of high-level features and a corresponding actual wait time; and
providing the estimated wait time to the user, the estimated wait time indicating an estimated duration of time until the pending support request is answered.

14. The system of claim 13, wherein the plurality of high-level features associated with the pending support request further comprises at least one of an actual wait time for a previously answered support request, an identification of a business associated with the pending support request, or an identification of a business queue associated with the business.

15. The system of claim 14, wherein the plurality of high-level features further comprise at least one of:
a time of day indication, the time of day indication indicating a time of day the pending support request was received; or
an average resolution time, the average resolution time representative of an average amount of time support agents associated with the respective business identification and respective queue identification take to complete a corresponding support request.

16. The system of claim 13, wherein each training support request in the corpus of training support requests comprise a plurality of historical support requests previously processed by the data processing hardware.

17. The system of claim 16, wherein the wait time predictor model is trained at a configurable frequency using the corresponding plurality of high-level features and the corresponding actual wait time for each of the historical support requests during the configurable frequency.

18. The system of claim 17, wherein the configurable frequency comprises once per day.

19. The system of claim 13, wherein the operations further comprise, after the pending support request is answered:
determining an actual wait time for the user, the actual wait time indicating an actual duration of time from when the pending support request was received until the user receives the answer for pending support request; and
tuning the wait time predictor model using the actual wait time for the pending support request.

20. The system of claim 19, wherein the operations further comprise:
determining a loss of the wait time predictor model based on the estimated wait time predicted by the wait time predictor model and the actual wait time;
determining whether the loss satisfies a threshold relative to a loss of a previously trained model; and
reverting back to the previously trained model when the loss satisfies the threshold.

21. The system of claim 20, wherein determining the loss comprises using a mean squared error.

22. The system of claim 13, wherein the predicted wait time model comprises a neural network.

23. The system of claim 22, wherein the neural network comprises a regressor deep neural network.

24. The system of claim 22, wherein the neural network comprises a deep neural network having a first hidden layer and a second hidden layer.
